(19) United States
(12) Patent Application Publication
(10) Pub. No.: US 2026/0272115 A1
(43) Pub. Date: Sep. 17, 2026

(54) BREATHABLE DEVICE APPLIED TO SHOE SOLE, PREPARATION METHOD THEREFOR, AND SHOE SOLE

(71) Applicant: FUJIAN QUANZHOU JINGHUXI TECHNOLOGY CO., LTD, Quanzhou (CN)

(72) Inventors: Xinlan DING, Quanzhou (CN); Junjie DING, Quanzhou (CN); Jiayi DING, Quanzhou (CN); Rongda ZHENG, Quanzhou (CN); Weizhi ZHUANG, Quanzhou (CN); Sien DING, Quanzhou (CN)

(73) Assignee: FUJIAN QUANZHOU JINGHUXI TECHNOLOGY CO., LTD, Quanzhou (CN)

(21) Appl. No.: 19/678,577

(22) Filed: May 15, 2026

Related U.S. Application Data
(63) Continuation of application No. PCT/CN2025/070495, filed on Jan. 3, 2025.

(30) Foreign Application Priority Data
Nov. 25, 2024 (CN) 202411697557.5

(51) Int. Cl. A43B 17/08; A43B 17/10

(52) U.S. Cl. CPC A43B 17/08; A43B 17/107

(57) ABSTRACT

A breathable device applied to a shoe sole, a preparation method therefor, and a shoe sole are provided. The breathable device includes: a pad and a waterproof and breathable fabric covering a surface of the pad, where a plurality of protrusions are disposed on the surface of the pad, a plurality of breathable holes are provided within the protrusions, a peripheral edge of the waterproof and breathable fabric is provided with a plurality of circular holes penetrating a thickness of the peripheral edge, and a gasket is laminated on the peripheral edge of the waterproof and breathable fabric and is integrally formed with the pad by penetrating through the circular holes. The preparation method includes: manufacturing an inner ring component that is semi-finished using a mold A; placing the inner ring component into a lower mold of a mold B; and injecting a TPU material into the mold B.

### CROSS REFERENCE TO RELATED APPLICATION

This application is a continuation of International Application No. PCT/CN2025/070495, filed on January 3, 2025, and claims priority to Chinese Application No. 202411697557.5, filed with the China National Intellectual Property Administration on November 25, 2024, which is incorporated herein by reference in its entirety.

### TECHNICAL FIELD

The present disclosure relates to the technical field of breathable shoes, and particularly, to a breathable device applied to a shoe sole, a preparation method therefor, and a shoe sole.

### BACKGROUND

Shoes are composed of shoe uppers and shoe soles, and are configured to protect feet walking on the ground from being punctured by sharp objects. Conventional shoes enhance breathability through the upper, and soles thereof are made of thermal insulation materials and have no breathability, which makes it difficult for sweat on the soles of the feet to be discharged. This leads to the growth of fungi and molds, causing dietetic neuritis and endangering the foot health of a wearer.

To enhance breathability, shoes available on the market are provided with breathable holes on side surfaces of the shoe soles, and airflow is inhaled or discharged through the shoe soles, thereby improving the efficiency of air circulation between the shoes and the outside. For example, as disclosed in Chinese Utility Model Patent Publication No. CN219939844U, a shoe sole with good breathability and a shoe including the shoe sole are provided. The shoe sole includes a shoe sole body, where a shoe groove with an upper opening is provided in the shoe sole body, a supporting edge and a supporting beam are provided at a bottom wall of the shoe groove, an outer wall of the supporting edge is connected to an inner wall of the shoe groove, and a plurality of breathable holes penetrating the supporting edge are provided in the shoe sole body. A breathable insole is provided for the shoe sole, which can provide a certain waterproof performance and ensure good breathability. However, such shoes have poor waterproof and dustproof performance. When the wearer walks on a road with a lot of surface dust for a period of time, small breathable holes of the shoes are easily clogged by accumulated dust, greatly reducing the breathability of the shoe sole. In addition, water on the road surface easily enters the shoe sole through the breathable holes, resulting in poor waterproof performance and an unsatisfactory wearing experience.

### SUMMARY

The present disclosure provides a breathable device applied to a shoe sole, a preparation method therefor, and a shoe sole, to solve the problems in the above-mentioned shoe, such as reduced breathability due to a fact that breathable holes are easily blocked by dust, and poor waterproof performance due to a fact that water easily enters the shoe through the breathable holes to form water accumulation.

One or more embodiments of the present disclosure provide a breathable device applied to a shoe sole, and the breathable device includes: a pad and a waterproof and breathable fabric covering a surface of the pad, where a plurality of protrusions are disposed on the surface of the pad, a plurality of breathable holes are provided within the plurality of protrusions, a peripheral edge of the waterproof and breathable fabric is provided with a plurality of circular holes penetrating a thickness of the peripheral edge, and a gasket is laminated on the peripheral edge of the waterproof and breathable fabric and is integrally formed with the pad by penetrating through the circular holes.

In some embodiments, trenches communicating with each other are formed between the plurality of protrusions, and the trenches are configured to fill an injection molding material during a secondary injection molding process to bond the waterproof and breathable fabric.

In some embodiments, a plurality of bumps are disposed at bottoms of the trenches, and the plurality of bumps are configured to abut against the waterproof and breathable fabric.

In some embodiments, the pad and the gasket are integrally injection-molded from a TPU (thermoplastic polyurethane) material.

In some embodiments, each of the plurality of protrusions is provided with a plurality of inclined plates, and the plurality of breathable holes are formed between the plurality of inclined plates.

In some embodiments, a thickness of the pad is 1-3 mm.

One or more embodiments of the present disclosure further provide a preparation method for a breathable device applied to a shoe sole, and the preparation method includes the following steps:

placing a TPU material into a cavity of a lower mold of a mold A; closing an upper mold of the mold A; heating for molding; and then cooling and opening the mold A to obtain an inner ring component, where the inner ring component is a semi-finished product of the breathable device, a surface of the inner ring component comprises the plurality of protrusions, a trench structure is formed between the plurality of protrusions, and all trenches are interconnected to form a grid shape;

taking a piece of the waterproof and breathable fabric; and punching holes in the piece of the waterproof and breathable fabric to form the plurality of circular holes, where the plurality of circular holes are adapted to the peripheral edge of the waterproof and breathable fabric and arranged in a circular shape;

placing the inner ring component obtained in a previous step into a cavity of a lower mold of a mold B; leaving a gap between the inner ring component and a peripheral side wall of the cavity of the lower mold of the mold B to form a peripheral edge cavity; hanging the waterproof and breathable fabric on an upper mold of the mold B; closing the upper mold of the mold B; injecting the TPU material into the cavity of the lower mold of the mold B; and bonding the inner ring component and the waterproof and breathable fabric through the TPU material to form an integrated structure; and

after cooling, opening the mold B to obtain a primary breathable device; and trimming the waterproof and breathable fabric that is excessive along an edge of the primary breathable device to obtain the breathable device.

In some embodiments, a bottom surface of the upper mold of the mold B is provided with an annular groove, the annular groove is aligned with the peripheral edge cavity, and the TPU material can penetrate through the plurality of circular holes in the waterproof and breathable fabric and flows into the annular groove.

In some embodiments, positioning posts that are mutually corresponding are disposed within the cavity of the lower mold of the mold A and the cavity of the lower mold of the mold B, and the inner ring component is provided with positioning holes matched with the positioning posts.

One or more embodiments of the present disclosure further provide a shoe sole, and the shoe sole includes a midsole, where an upper surface of the midsole is provided with a groove, the breathable device applied to the shoe sole is disposed within the groove, and a bottom of the groove is penetrated by through holes that are in one-to-one correspondence to the plurality of protrusions.

In some embodiments, an outsole is bonded to a bottom of the midsole.

From the above description of the present disclosure, compared with the prior art, the breathable device provided by the present disclosure has the following advantages:
1. In some embodiments of the present disclosure, a mold A is adopted to manufacture an inner ring component that is semi-finished, then the inner ring component is placed into a lower mold of a mold B, a TPU material is injected into the mold B, and the TPU material flows into a trench of the inner ring component and a peripheral edge cavity of a cavity of the lower mold of the mold B; meanwhile, the TPU material penetrates through the circular holes in the waterproof and breathable fabric and flows into an annular groove of an upper mold of the mold B, so that the inner ring component and the waterproof and breathable fabric are bonded with the TPU material that is secondarily injected to form an integrated structure. The TPU material clamps the peripheral edge of the waterproof and breathable fabric from top to bottom, ensuring that the waterproof and breathable fabric is firmly connected to the inner ring component and the peripheral edge thereof is not prone to delamination.
2. In some embodiments of the present disclosure, the bumps of this application are reserved in the trenches of the inner ring component, and the bumps abut against the waterproof and breathable fabric, so that the waterproof and breathable fabric remains flat and is not easily depressed into the trenches. The trenches remain unobstructed, which facilitates uniform injection of the TPU material into the trenches.
3. In some embodiments of the present disclosure, the inner ring component of this application is provided with a plurality of protrusions, the protrusions are provided with anti-puncture inclined plates, and breathable holes are formed between the inclined plates. The breathable holes have a large aperture and are not easily clogged by dust, achieving excellent breathability. The waterproof and breathable fabric covers the surfaces of the protrusions, and is not prone to blocking the breathable holes, and the inner ring component has excellent waterproof performance and breathability.
4. In some embodiments of the present disclosure, the breathable device of this application is installed in the shoe sole, the shoe sole is provided with a groove adapted to the breathable device, and a plurality of breathable holes with large apertures are provided at the bottom of the groove. This design optimizes the breathability of the shoe sole and ensures excellent waterproof performance and breathability.
5. In some embodiments of the present disclosure, parallel inclined plates are arranged inside the protrusions of this application, strip-shaped breathable holes are formed between the inclined plates, the inclined plates have an anti-puncture function, which protects the sole of the foot from being punctured by sharp objects on the ground, ensuring that the shoe is safer to wear and walk in, with a reasonable structural design.

### BRIEF DESCRIPTION OF THE DRAWINGS

FIG. 1A is a schematic structural diagram of a mold A according to the present disclosure.

FIG. 1B is a schematic structural diagram of a cavity of a lower mold of the mold A according to some embodiments of the present disclosure.

FIG. 2 is a schematic structural diagram of a mold B according to the present disclosure.

FIG. 3 is a schematic structural diagram of a cavity of a lower mold of the mold B according to the present disclosure.

FIG. 4 is a schematic structural diagram of a waterproof and breathable fabric according to the present disclosure.

FIG. 5 is a schematic structural diagram of an inner ring component according to the present disclosure.

FIG. 6 is a schematic structural diagram of a pad according to the present disclosure.

FIG. 7 is a schematic structural diagram of a breathable device according to the present disclosure.

FIG. 8 is a schematic structural diagram of a midsole without a breathable device according to the present disclosure.

FIG. 9 is a schematic structural diagram of a midsole with a breathable device according to the present disclosure.

FIG. 10 is a schematic sectional structural diagram of a midsole with a breathable device according to the present disclosure.

FIG. 11 is an upward schematic structural diagram of a shoe sole according to the present disclosure.

FIG. 12 is a schematic flowchart illustrating preparation of a breathable device according to some embodiments of the present disclosure.

### DETAILED DESCRIPTION OF THE EMBODIMENTS

In order to more clearly illustrate technical solutions of embodiments of the present disclosure, the accompanying drawings needed in the descriptions of the embodiments will be briefly introduced below. Apparently, the accompanying drawings in the following descriptions are merely some examples or embodiments of the present disclosure, and ordinary persons skilled in the art may apply the present disclosure to other similar situations based on these accompanying drawings without creative labor. Unless otherwise apparent from the context or specifically stated, identical reference numerals in the accompanying drawings represent identical structures or operations.

As shown in the present disclosure and claims, unless the context clearly indicates otherwise, terms such as “a,” “one”, “an”, and/or “the” are not limited to a singular form and may also include a plural form. Generally, terms “comprise” and “include” merely indicate that steps and elements explicitly identified are included, and such steps and elements do not constitute an exclusive listing; methods or devices may also include other steps or elements.

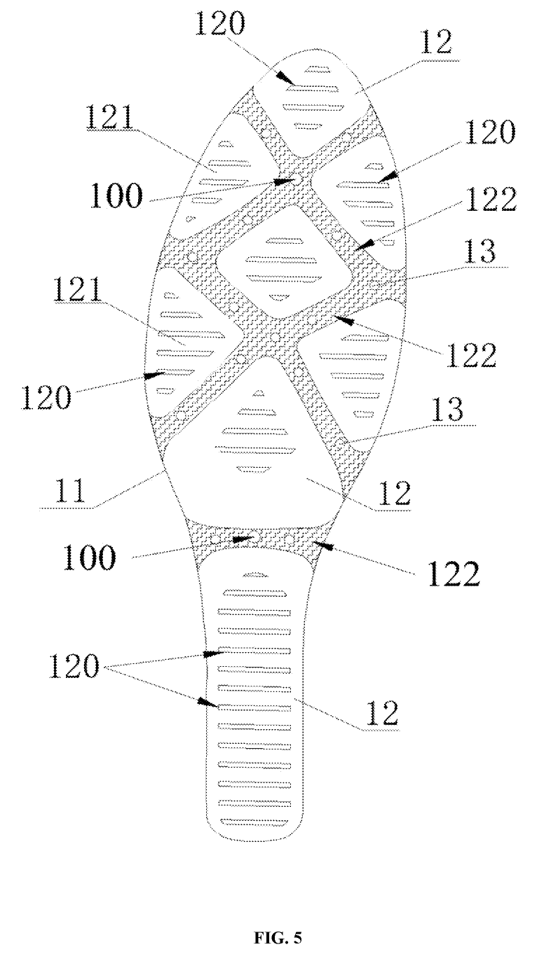

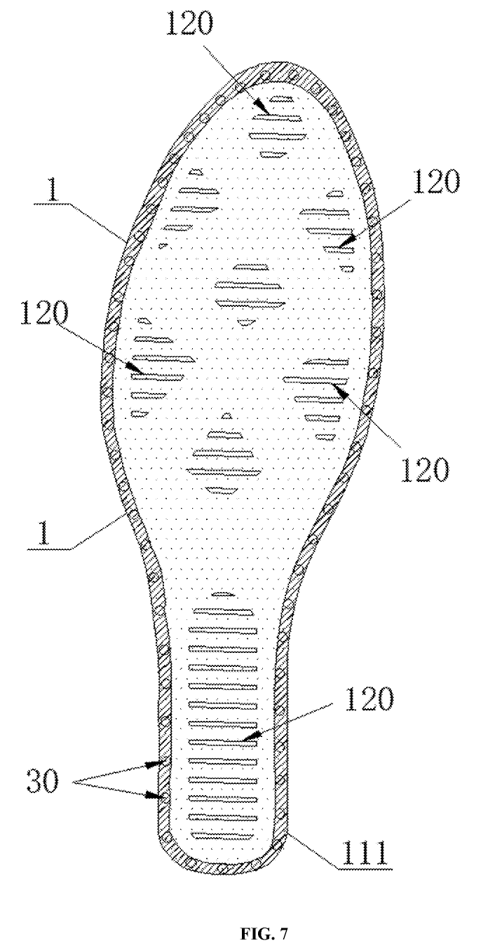

In some embodiments, refer to FIG. 5 to FIG. 7. A breathable device applied to a shoe sole includes a pad 1 and a waterproof and breathable fabric 3 covering a surface of the pad 1, where a plurality of protrusions 12 are disposed on the surface of the pad 1, a plurality of breathable holes 120 are provided within the plurality of protrusions 12, a peripheral edge of the waterproof and breathable fabric 3 is provided with a plurality of circular holes 30 penetrating a thickness of the peripheral edge, and a gasket 111 is laminated on the peripheral edge of the waterproof and breathable fabric 3 and is integrally formed with the pad 1 by penetrating through the circular holes 30.

The pad 1 refers to a base component for supporting the waterproof and breathable fabric 3. In some embodiments, the pad may be made of a material such as TPU or EVA (Ethylene Vinyl Acetate Copolymer). In some embodiments, a contour shape of the pad 1 is adapted to the shoe sole. For example, the pad 1 may be configured in a heel shape, an arch shape or a forefoot shape, so as to be stably embedded within the shoe sole and cover a main breathable region.

In some embodiments, a thickness of the pad 1 is 1-3 mm. In some embodiments, the thickness of the pad 1 is 2 mm. The thickness of the pad 1 refers to a distance from a lower surface of the pad 1 to a top surface of the protrusion 12. It can be understood that the thickness of the pad 1 is not limited to a specific value of 1-3 mm as described above, as long as the pad can provide sufficient support rigidity for the waterproof and breathable fabric 3 and adapt to a depth of a groove 20 of the shoe sole. For example, in different application scenarios such as lightweight sports shoes or outdoor work shoes, the thickness of the pad 1 may be adjusted to be less than 1 mm or more than 3 mm according to an actual force and assembly requirements.

The waterproof and breathable fabric 3 refers to a fabric for covering an upper surface of the pad 1. In some embodiments, the waterproof and breathable fabric 3 may allow water vapor to pass downward from an interior of the shoe through the shoe sole to external atmosphere, while blocking liquid water from an external road surface from penetrating reversely from an exterior of the shoe sole into an inner chamber of the shoe. In some embodiments, the waterproof and breathable fabric 3 may be formed by laminating a polymer waterproof and breathable material such as a PTFE (polytetrafluoroethylene) film with a base fabric. For example, a GORE-TEX brand fabric marketed by W. L. Gore & Associates, Inc. may be adopted. In some embodiments, a contour shape of the waterproof and breathable fabric 3 is substantially consistent with an outer contour of the pad 1, so as to fully cover the plurality of protrusions 12 and facilitate reliable fixation of the peripheral edge of the pad 1 by the gasket 111.

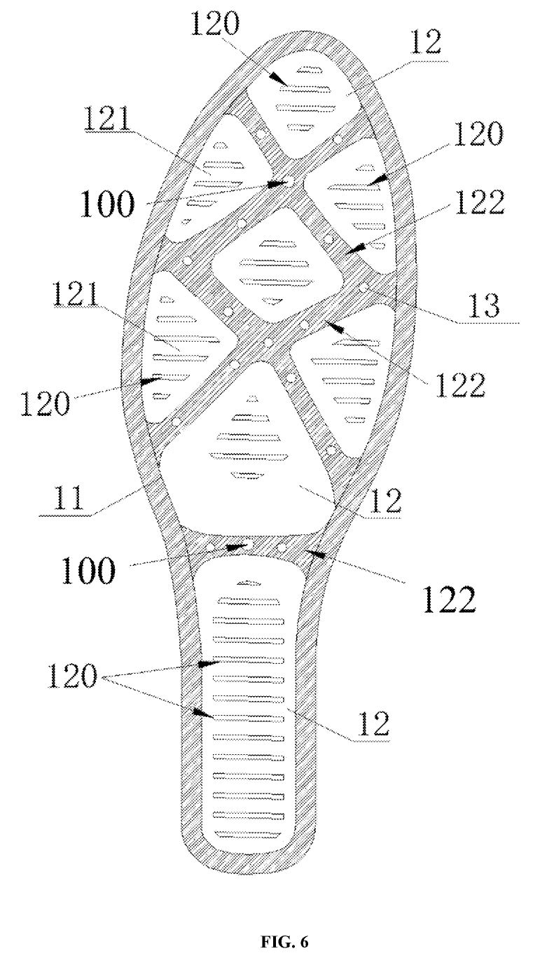

The protrusion 12 refers to a bulged structure on the pad 1. The protrusion 12 may be configured to support the waterproof and breathable fabric 3 and form an air circulation channel. In some embodiments, an outer contour shape of each protrusion 12 includes, but is not limited to, one or more of circular, elliptical and polygonal shapes. In some embodiments, the protrusion 12 is located on the upper surface of the pad 1 (namely, a surface facing the sole of the foot). In some embodiments, the plurality of protrusions 12 may be distributed in an array or partitioned manner according to a force-bearing region of the shoe sole. For example, as shown in FIG. 5 and FIG. 6, the plurality of protrusions 12 are arranged in a regular grid to cover the main breathable region. It can be understood that the specific number, layout density and arrangement of the plurality of protrusions 12 are not limited to those shown in the drawings, as long as the plurality of protrusions 12 can form supports on the upper surface of the pad 1 and constitute a communicating air circulation channel. In some embodiments, the protrusion 12 and the pad 1 are integrally injection-molded to ensure connection strength and structural integrity between the protrusion 12 and the pad 1, thereby preventing relative displacement or detachment during use.

The breathable hole 120 refers to a pore structure for air circulation. In some embodiments, one or more breathable holes 120 may be provided on each protrusion 12. In some embodiments, the breathable holes 120 are provided inside the protrusion 12 of the pad 1 and penetrate through the protrusion 12 in a thickness direction of the pad 1, so that an upper surface of the protrusion 12 communicates with the lower surface of the pad 1. In some embodiments, the breathable holes 120 may be integrally formed with the pad 1 and the protrusion 12 during injection molding. In some embodiments, the external shape of the breathable holes 120 may be rounded rectangle, elliptical, polygonal, or the like.

The peripheral edge of the waterproof and breathable fabric 3 refers to a region at an outermost edge of the waterproof and breathable fabric 3. For example, the peripheral edge of the waterproof and breathable fabric 3 may be a region along the outermost edge of the waterproof and breathable fabric 3 and with a width of 5-10 mm.

The gasket 111 refers to a structure disposed along the peripheral edge of the waterproof and breathable fabric 3. The gasket 111 may be configured to fix the waterproof and breathable fabric 3 onto the pad 1. In some embodiments, during injection molding, the gasket 111 is integrally formed with the pad 1 by penetrating through the circular holes 30 in the waterproof and breathable fabric 3, so that the gasket 111 and the pad 1 jointly clamp the peripheral edge of the waterproof and breathable fabric 3 from top to bottom.

The circular holes 30 are configured to allow a molten injection molding material to pass through during a secondary injection molding, so that the gasket 111 and the pad 1 are integrally formed and clamp the waterproof and breathable fabric 3 from top to bottom. In some embodiments, a cross-sectional shape of the circular holes 30 is not limited to be circular, and may also be elliptical, rectangular, kidney-shaped, or cross-shaped, as long as the circular holes 30 allow a molten TPU material to pass through, and form connecting posts between the gasket 111 and the pad 1 after curing.

In some embodiments, a cross section of the gasket 111 (that is, a section perpendicular to a circumferential direction of the gasket) is rectangular, semicircular, U-shaped, or trapezoidal, and a width thereof may be equal to or different from a width of the peripheral edge of the waterproof and breathable fabric 3. The width of the gasket 111 refers to a dimension of the gasket 111 in a radial direction of the pad 1 (that is, a direction from an inner ring to an outer ring). In other some embodiments, the gasket 111 is not a complete continuous ring, but is composed of a plurality of gasket blocks that are discrete. Each gasket block is corresponding to one or more circular holes 30. For example, the plurality of gasket blocks may be spaced apart along the peripheral edge of the waterproof and breathable fabric 3, for example, uniformly spaced or densely arranged in specific regions (such as corners or regions with a large curvature). This reduces the amount of the molten injection molding material used and improves flexibility of the peripheral edge of the pad 1 while ensuring the clamping and fixing effect. It can be understood that the shape of the gasket blocks is not limited to be rectangular or semicircular, and may also be cylindrical, elliptical cylindrical, or irregular blocks, as long as each gasket block is integrally formed with the pad 1 by penetrating through the corresponding circular holes 30 and presses the peripheral edge of the waterproof and breathable fabric 3 from above.

In some embodiments of the present disclosure, the protrusions 12 with the breathable holes 120 are disposed on the upper surface of the pad 1 and covered with the waterproof and breathable fabric 3, so as to achieve effective breathable and waterproof performance of the shoe sole. Meanwhile, the circular holes 30 are formed in the peripheral edge of the waterproof and breathable fabric 3, and the gasket 111 is integrally formed with the pad 1 by penetrating through the circular holes 30, thereby firmly clamping the edge of the waterproof and breathable fabric 3 from top to bottom. This significantly enhances the connection strength between the waterproof and breathable fabric 3 and the pad 1, effectively prevents delamination of the peripheral edge, and prolongs the service life of the breathable device.

In some embodiments, as shown in FIG. 5 and FIG. 6, trenches 122 communicating with each other are formed between the plurality of protrusions 12, and the trenches 122 are configured to fill an injection molding material to bond the waterproof and breathable fabric 3 during the secondary injection molding

In some embodiments, a width of the trench 122 (that is, a horizontal distance between adjacent protrusions 12) and a gap between a bottom of the trench and the lower surface of the waterproof and breathable fabric 3 (that is, a distance between the bottom of the trench and a top surface of the protrusion 12) may be flexibly set by those skilled in the art according to the specific injection molding process, material flowability, and thickness requirements of the breathable device, and in combination with experience or actual working conditions, so as to ensure that the molten TPU material can flow in smoothly, and an overall thickness of the breathable device is not affected by an excessively thick TPU material layer due to an excessively large gap. In some embodiments, the gap may be set by adjusting a height of the protrusion 12, for example, an increased height of the protrusion 12 indicates an increased gap, and vice versa.

The injection molding material refers to a material that is heated and melted by injection molding and injected into a mold cavity to form the pad 1 and the gasket 111 in the breathable device, and bond the waterproof and breathable fabric 3. In some embodiments, the injection molding material is the TPU material.

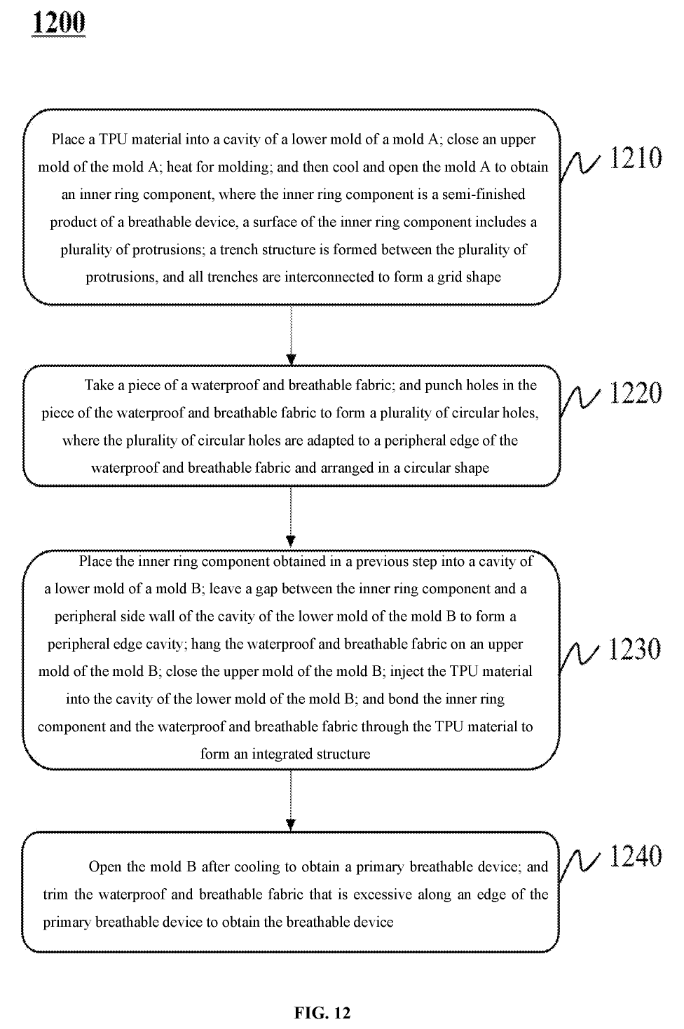

In some embodiments, all the trenches 122 are interconnected in a grid or honeycomb pattern, forming a continuous network channel. The continuous network channel serves as a flow path for the injection molding material during the secondary injection molding. For more details on the secondary injection molding, refer to relevant descriptions of FIG. 12.

In some embodiments of the present disclosure, interconnected trenches are provided between the plurality of protrusions, so that a molten injection molding material injected during the secondary injection molding can flow uniformly along a trench network and achieve full filling. This forms a large-area continuous bonding region between the pad 1 and the waterproof and breathable fabric 3, enhancing bonding strength between the pad 1 and the waterproof and breathable fabric 3 and avoiding poor bonding caused by local material deficiency.

In some embodiments, referring to FIG. 5, a plurality of bumps 13 are disposed at bottoms of the trenches 122, and the plurality of bumps 13 are configured to abut against the waterproof and breathable fabric 3.

In some embodiments, the plurality of bumps 13 may be in the form of columns, truncated cones, or other structures. In some embodiments, the plurality of bumps 13 are spaced apart along a length direction of the trench 122, and a distribution density of the plurality of bumps 13 may be adjusted according to the width of the trenches and requirements of injection molding. In some embodiments, the plurality of bumps 13 and the pad 1 are integrally formed by injection molding, so as to ensure connection strength and dimensional accuracy between the plurality of bumps 13 and the bottoms of the trenches 122. In some embodiments, the plurality of bumps 13 may also be fixed to the bottoms of the trenches 122 by bonding or ultrasonic welding, as long as the plurality of bumps 13 can stably support the waterproof and breathable fabric 3.

The plurality of bumps 13 may support the waterproof and breathable fabric 3 by abutting against the waterproof and breathable fabric 3, so as to prevent the waterproof and breathable fabric 3 from sagging down to the bottoms of the trenches 122 due to its own weight or injection molding pressure.

In some embodiments of the present disclosure, the plurality of bumps 13 are disposed at the bottoms of the trenches and are configured to abut against and support the waterproof and breathable fabric 3, which effectively prevents the waterproof and breathable fabric 3 from sagging down to the bottom of the trench due to gravity or pressure during injection molding. This keeps the waterproof and breathable fabric 3 flat, ensures smooth flow and uniform filling of the molten injection molding material in the trench, and avoids poor bonding or material deficiency caused by the fabric adhering to the bottom. In addition, after the plurality of bumps 13 are embedded in a secondary injection molding material, a mechanical interlock is formed, further enhancing bonding strength between the pad 1 and the waterproof and breathable fabric 3.

In some embodiments, the pad 1 and the gasket 111 are integrally injection-molded from the TPU material.

In some embodiments, the gasket 111 and the pad 1 penetrate through the circular holes 30 at the peripheral edge of the waterproof and breathable fabric 3 through the TPU material for secondary injection molding, so that the gasket 111 is formed on the upper surface of the waterproof and breathable fabric 3, and the pad 1 is located on the lower surface of the waterproof and breathable fabric 3. The gasket 111 and the pad 1 respectively clamp the peripheral edge of the waterproof and breathable fabric 3 from top to bottom, forming a firm upper and lower clamping combination.

In some embodiments of the present disclosure, the pad 1 and the gasket 111 are integrally molded by injection molding, so that the pad 1 and the gasket 111 are directly fused into a single unit at a material level without additional adhesives or mechanical connections. This significantly improves bonding strength between the gasket 111 and the pad 1, avoids the risk of delamination caused by prolonged bending or humid environments, simplifies a manufacturing process and reduces a production cost.

In some embodiments, as shown in FIG. 5 and FIG. 6, each of the plurality of protrusions 12 is provided with a plurality of inclined plates 121, and the plurality of breathable holes 120 are formed between the plurality of inclined plates 121.

In some embodiments, the inclined plates may be in the form of a rectangular flat plate, an arc-shaped plate, a wavy plate, or the like, so as to ensure smoothness of the breathable holes 120 and improve puncture resistance stiffness.

In some embodiments, the plurality of inclined plates 121 are arranged in parallel and spaced apart from each other, and a gap between adjacent inclined plates 121 forms a breathable hole 120. Each inclined plate 121 is disposed obliquely with respect to the top surface of the protrusion 12, and an inclination angle and an inclination direction thereof can be adjusted according to a force-bearing direction of the shoe sole and breathability. For example, in the protrusion 12 of a heel region, the inclined plates 121 are inclined toward a heel direction to guide moist and hot gas to be discharged backward during walking compression. In some embodiments, the inclined plates 121 and the protrusions 12 are integrally formed by injection molding, thereby ensuring structural strength and long-term use stability. It can be understood that a specific inclination direction and arrangement form of the inclined plates 121 are not limited to the above examples, as long as the inclined plates 121 can extend inward from the protrusions 12 to form the breathable holes 120.

In some embodiments, the number, thickness (that is, a dimension of the inclined plate in a normal direction of a plate surface), and arrangement spacing of the inclined plates 121 may be adaptively adjusted according to specific specifications of the shoe sole, intended use environment (such as outdoor scenarios, construction site, and daily commuting), and requirements for puncture resistance level. For example, in scenarios requiring higher puncture resistance, the thickness of the inclined plates 121 may be appropriately increased or a spacing between adjacent inclined plates can be reduced, and an equivalent diameter of the breathable holes 120 is maintained to meet gas exchange requirements. The puncture resistance level refers to a metric that quantifies a capability of the shoe sole to resist penetration from sharp objects (such as nails, broken glass, and sharp stones) from the ground upward to the sole of the foot. In some embodiments, the puncture resistance level may be classified according to a test method specified by industry standards (such as GB/T 20991or ASTM F2412).

In some embodiments of the present disclosure, the plurality of inclined plates 121 are disposed inside each protrusion 12, so that the breathable holes 120 are formed between the inclined plates 121. On the one hand, the breathable holes 120 are strip-shaped or slit-shaped with large opening area, are less susceptible to dust clogging, and can maintain favorable breathability over long-term use. On the other hand, the inclined plates 121 themselves have certain structural strength and rigidity, which can serve as a physical barrier and stress dispersion when the shoe sole is subjected to upward puncture by sharp objects, significantly improving puncture resistance safety. Meanwhile, the inclined plates 121 provide uniform support for the waterproof and breathable fabric 3 covered thereon, preventing the waterproof and breathable fabric 3 from sagging and deformation, and comprehensively enhancing the service life, safety, and structural stability of the breathable device.

In some embodiments, preparation of the breathable device may be implemented based on automated process equipment (not shown in the figure). The automated process equipment is a dedicated injection molding system for manufacturing the breathable device of the shoe sole. In some embodiments, the automated process equipment includes a controller, an actuator system, an injection molding system, a temperature control system, or the like.

The controller refers to a data processing unit configured to receive and process data and generate and issue control instructions. In some embodiments, the controller may include one or a combination of a programmable logic controller, an industrial embedded controller, and a dedicated safety controller.

The actuator system refers to an automated mechanical subsystem for automatically completing operations (such as material grabbing, positioning, placement, and auxiliary actions) according to control instructions. In some embodiments, the actuator system includes, but is not limited to, components such as robotic arms, robots, and drive components (such as cylinders or electric cylinders).

The injection molding system refers to a process device for injection molding. In some embodiments, the injection molding system includes, but is not limited to, an injection mold, an injection unit, a heating barrel, or the like.

The temperature control system refers to a subsystem for monitoring and adjusting a mold temperature. In some embodiments, the temperature control system includes, but is not limited to, a mold temperature controller, a cooling water circuit, or the like. The temperature control system can ensure that the injection molding material is cured at an appropriate temperature and maintains stability of product dimensions during molding.

In some embodiments, the controller may send the control instructions to other systems to control execution of related operations by other systems. For example, the controller may send the control instructions to the actuator system to enable the robotic arm to automatically grab the inner ring component 11 and accurately place the inner ring component 11 into the cavity of the lower mold of the mold B. The controller may also send the control instructions to the injection molding system to enable an injection molding unit to inject the TPU material into the mold B according to a preset injection molding pressure, speed, and holding time. Meanwhile, the controller may also send the control instructions to the temperature control system to enable the mold temperature controller to adjust a mold temperature to a set range, ensuring that the injection molding material is cured under appropriate conditions, thereby achieving automated control of an entire process for preparing the breathable device. In some embodiments, a preparation process for the breathable device is not limited to automated control and may also be implemented manually. For example, an operator manually performs steps such as taking and placing the inner ring component 11, hanging the waterproof and breathable fabric 3, and adjusting injection molding parameters.

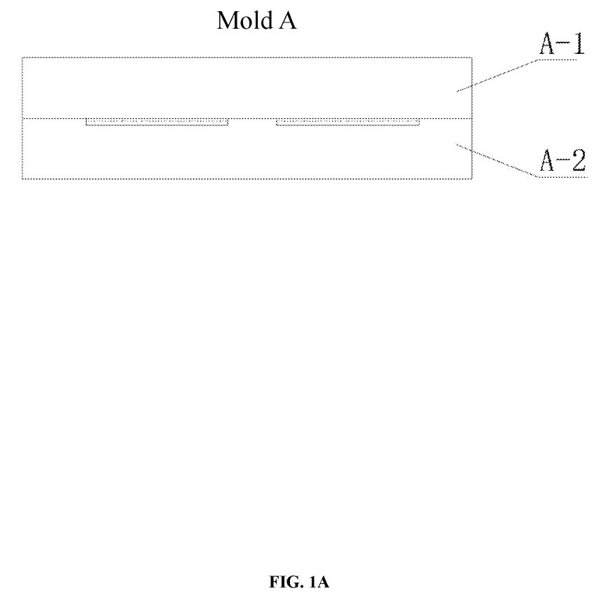

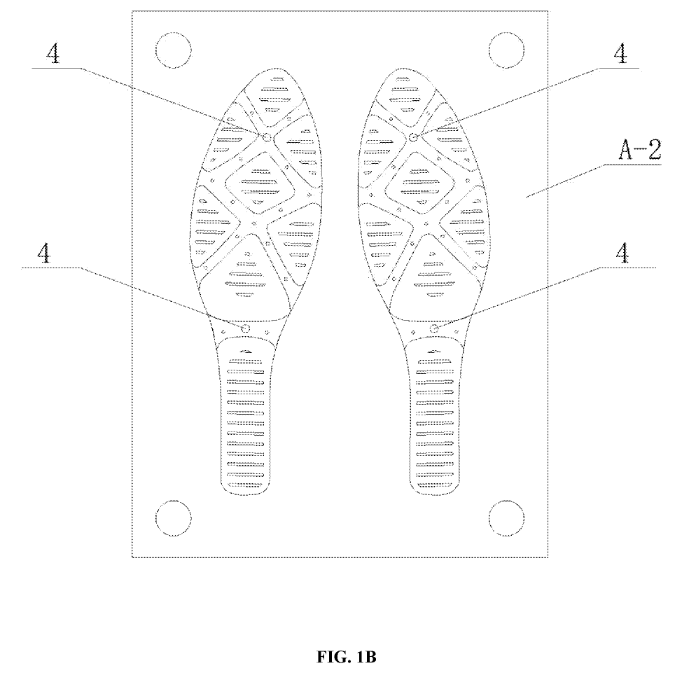

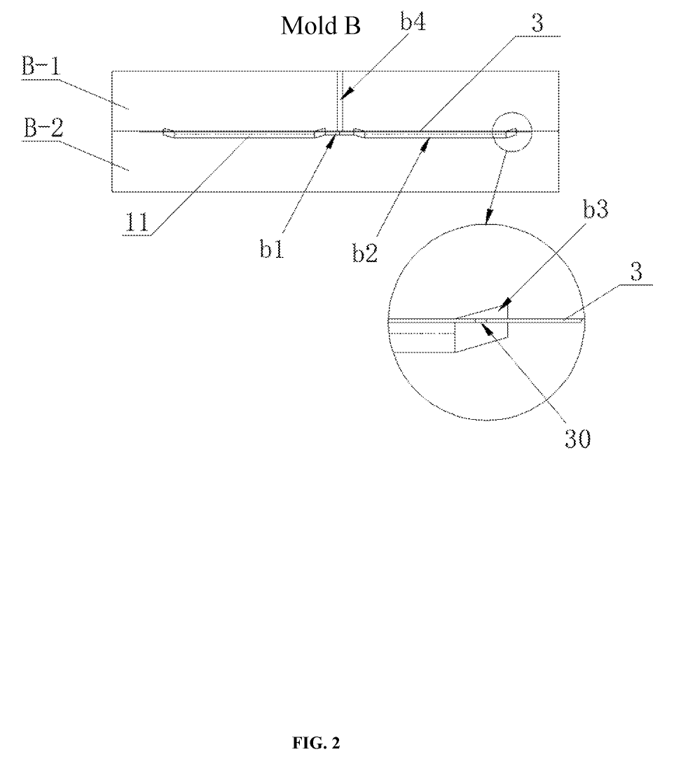

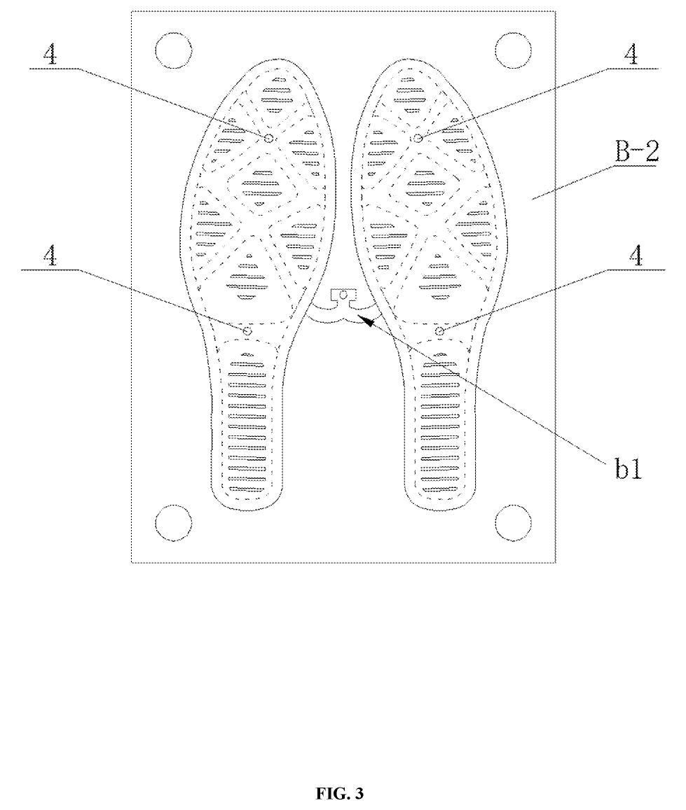

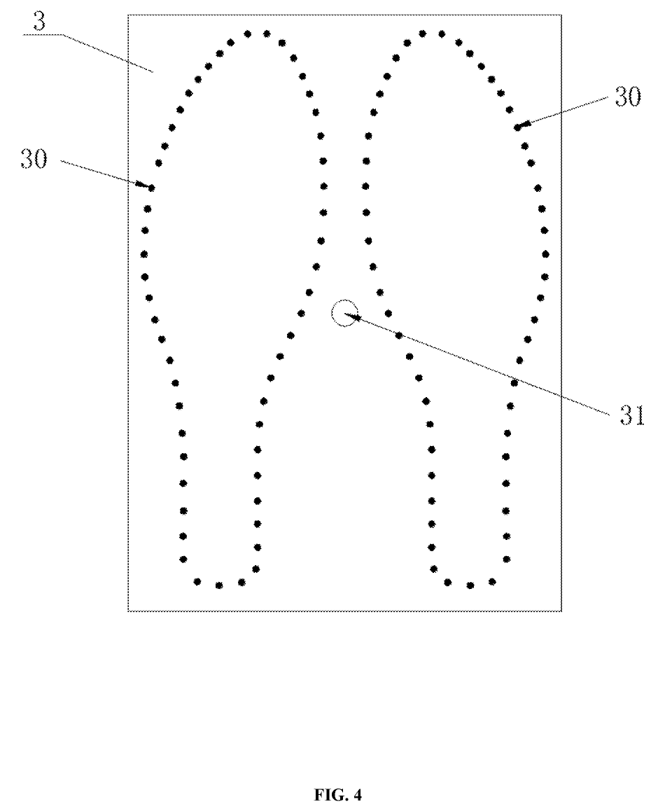

FIG. 1A is a schematic structural diagram of a mold A according to the present disclosure. FIG. 1B is a schematic structural diagram of a cavity of a lower mold of the mold A according to the present disclosure. FIG. 2 is a schematic structural diagram of a mold B according to the present disclosure. FIG. 3 is a schematic structural diagram of a cavity of a lower mold of the mold B according to the present disclosure. FIG. 4 is a schematic structural diagram of a waterproof and breathable fabric according to the present disclosure. FIG. 12 is a schematic flowchart illustrating preparation of a breathable device according to some embodiments of the present disclosure.

In some embodiments, as shown in FIG. 1A, FIG. 1B, FIGS. 2-6, and FIG. 12, a preparation method for a breathable device applied to a shoe sole includes the following steps:

Step 1210: placing a TPU material into the cavity of the lower mold of the mold A; closing an upper mold A-1 of the mold A; heating for molding; and then cooling and opening the mold A to obtain the inner ring component 11, where the inner ring component 11 is a semi-finished product of the breathable device, a surface of the inner ring component 11 includes the plurality of protrusions 12, a trench structure is formed between the plurality of protrusions 12, and all trenches 122 are interconnected to form a grid shape. This step may be performed by the actuator system controlled by the controller or manually.

The mold A refers to a mold configured to process the inner ring component 11. In some embodiments, the mold A includes the upper mold A-1 and a lower mold A-2. The upper mold A-1 includes the cavity of the upper mold, the lower mold A-2 includes the cavity of the lower mold, and the cavity of the upper mold and the cavity of the lower mold together form the cavity of the mold A. A shape of the cavity of the mold A is adapted to a shape of the inner ring component 11, so that the TPU material is molded into the inner ring component 11 in the cavity of the mold A.

The inner ring component 11 refers to a semi-finished product of the breathable device. In some embodiments, the inner ring component 11 forms a main body of the pad 1 (that is, the plurality of protrusions 12, the trenches 122, and the bumps 13). A complete structure of the pad 1 is formed during a secondary injection molding, where the TPU material forms a peripheral edge of the pad 1 around the inner ring component 11 and fills the trenches 122 to bond with the inner ring component 11 into an integrated structure. The peripheral edge of the pad 1 refers to a region at an outermost edge of the pad 1. In some embodiments, the peripheral edge of the pad 1 is bonded and overlapped with the peripheral edge of the waterproof and breathable fabric 3 in a thickness direction of the pad 1.

In some embodiments, as shown in FIG. 5, the inner ring component 11 includes the plurality of protrusions 12, the plurality of bumps 13, and the interconnected trenches 122. For more details regarding the protrusions 12, bumps 13, and the trenches 122, refer to relevant descriptions in FIG. 5 to FIG. 7.

Step 1220: taking a piece of the waterproof and breathable fabric 3; and punching holes in the piece of the waterproof and breathable fabric 3 to form the plurality of circular holes 30, where the plurality of circular holes 30 are adapted to the peripheral edge of the waterproof and breathable fabric 3 and arranged in a circular shape. This step may be performed by the actuator system controlled by the controller or manually.

In some embodiments, the dimension and arrangement of the circular holes 30 may be set according to a contour of the peripheral edge of the waterproof and breathable fabric 3 and a flow path of the TPU material during the secondary injection molding.

In some embodiments, the number and distribution density of the circular holes 30 may be adjusted according to a length of the peripheral edge of the waterproof and breathable fabric 3 and the required bonding strength. For example, the distribution density of the circular holes may be appropriately increased at corners or regions with a larger curvature. It should be understood that any through-hole structure disposed at the peripheral edge of the waterproof and breathable fabric 3, regardless of the specific shape, dimension, number, or arrangement thereof, shall fall within an equivalent alternative to the circular holes described in the present disclosure as long as the through-hole structure allows the injection molding material to penetrate and achieve upper and lower clamping.

Step 1230: placing the inner ring component 11 obtained in a previous step into a cavity b2 of the lower mold of the mold B; leaving a gap between the inner ring component 11 and a peripheral side wall of the cavity b2 of the lower mold of the mold B to form a peripheral edge cavity; hanging the waterproof and breathable fabric 3 on an upper mold B-1 of the mold B; closing the upper mold B-1 of the mold B; injecting the TPU material into the cavity b2 of the lower mold of the mold B; and bonding the inner ring component 11 and the waterproof and breathable fabric 3 into an integrated structure through the TPU material. This step may be performed by the actuator system controlled by the controller or manually.

The mold B refers to a mold for secondary injection molding to form a finished breathable device. In some embodiments, the mold B includes the upper mold B-1 and a lower mold B-2, the upper mold B-1 includes the cavity of the upper mold, the lower mold B-2 includes the cavity b2 of the lower mold, and a feed hole b4 communicating with an injection molding unit is provided on the upper mold B-1. A guide hole b1 is provided in the lower mold B-2 of the mold B for guiding the TPU material from the feed hole b4 to the cavity b2 of the lower mold.

In some embodiments, as shown in FIG. 4, the waterproof and breathable fabric 3 is provided with a hole 31 aligned with the feed hole b4, and the molten TPU material penetrates through the feed hole b4 and the hole 31, and flows into the cavity b2 of the lower mold of the mold B along the guide hole b1. The hole 31 refers to a feed port of the injection molding material that is formed on the waterproof and breathable fabric 3.

The peripheral edge cavity refers to an annular space for receiving the TPU material injected to form the peripheral edge of the pad 1.

In some embodiments, the inner ring component 11 and the TPU material that is secondarily injected are made of a same or compatible thermoplastic material, and the inner ring component 11 and the TPU material are partially configured together during the secondary injection molding due to heating, thereby forming an integrated structure with material fusion. For example, the TPU material is configured to fill the peripheral edge cavity to form the peripheral edge of the pad 1, and the peripheral edge of the pad 1 is bonded to the inner ring component 11 to form an integrated structure. Meanwhile, the TPU material penetrates through the circular holes 30 in the waterproof and breathable fabric 3 to integrally connect the pad 1 and the gasket 111, so that the pad 1 and the gasket 111 jointly clamp and fix the peripheral edge of the waterproof and breathable fabric 3 from top to bottom.

In some embodiments, the TPU material is configured to fill the trenches 122 and is bonded to the waterproof and breathable fabric 3, so that the waterproof and breathable fabric 3 covers the upper surface of the pad 1. It is understood that the waterproof and breathable fabric 3 is bonded to the pad 1 only at the trenches 122 and the peripheral edge of the pad 1, and is not bonded at the plurality of protrusions 12, so that the waterproof and breathable fabric 3 can obtain a firm bond while avoiding large-area bonding that would block the micropores of the waterproof and breathable fabric 3, thereby maintaining good breathability of the waterproof and breathable fabric 3. In addition, it also prevents the TPU material from entering the breathable holes 120 and clogging the breathable holes 120.

Step 1240: opening the mold B after cooling to obtain a primary breathable device; and trimming the waterproof and breathable fabric 3 that is excessive along an edge of the primary breathable device to obtain the breathable device. This step may be performed by the temperature control system controlled by the controller, or may be completed by natural cooling.

The primary breathable device refers to an untrimmed semi-finished product formed by integral injection molding using the mold B, where the pad 1, the gasket 111, and the waterproof and breathable fabric 3 are integrally combined, with an excess fabric edge still reserved at the peripheral edge.

In some embodiments, a trimming method includes but is not limited to manual trimming, die cutting, laser cutting, or the like. It should be understood that any operation for removing an excess portion of the waterproof and breathable fabric 3 after injection molding, regardless of a type of trimming tool used or whether secondary edge sealing is performed on a trimmed edge, falls within the scope defined by this step. In some embodiments, a cutting edge may also be disposed on the upper mold B-1 or the lower mold B-2 of the mold B, and cutting is completed with mold closing and injection molding, thereby eliminating a separate trimming process.

In some embodiments of the present disclosure, by virtue of a “secondary injection molding” process, the inner ring component 11 with grid-shaped trenches 122 and protrusions 12 is molded by the mold A, and then the inner ring component 11 is placed into the mold B. Injection molding of the TPU material is performed in cooperation with the pre-punched waterproof and breathable fabric 3, so that the TPU material can flow uniformly along the interconnected trenches 122 and penetrate through the circular holes 30 in the waterproof and breathable fabric 3 to form an upper and lower clamping structure. This achieves integral and firm bonding of the inner ring component 11 and the waterproof and breathable fabric 3, and prevents delamination at the peripheral edge. Meanwhile, the method effectively prevents an adhesive from blocking the breathable holes 120 or micropores of the waterproof and breathable fabric 3, and ensures the waterproof and breathable performance of the breathable device. In addition, the secondary injection molding has high molding precision and a continuous process, which is conducive to mass production. The breathable device manufactured by the method has a peripheral edge that is not easily delaminated, with a stable and reliable overall structure.

In some embodiments, as shown in FIG. 2, a bottom surface of the upper mold B-1 of the mold B is provided with an annular groove b3, the annular groove b3 is aligned with the peripheral edge cavity, and the TPU material may penetrate through the plurality of circular holes 30 in the waterproof and breathable fabric 3 and flows into the annular groove b3.

The annular groove b3 refers to an annular recess configured to receive the TPU material injected through the circular holes 30 in the waterproof and breathable fabric 3 and allow the TPU material to cure and form the gasket 111. In some embodiments, the annular groove b3 is formed as the cavity of the upper mold of the mold B.

In some embodiments, a cross-sectional shape of the annular groove b3 (that is, a section perpendicular to an extension direction of the annular groove) may be rectangular, semicircular, U-shaped, trapezoidal, or the like. In some embodiments, a width of the annular groove may be adapted to a width of the peripheral edge of the pad 1, for example, less than or equal to the width of the peripheral edge of the pad 1. In some embodiments, a depth of the annular groove may be set by a skilled person based on experience.

In some embodiments, in a mold closure state, the annular groove b3, the circular holes 30 in the waterproof and breathable fabric 3, the peripheral edge cavity, and the trenches 122 together form a closed injection molding flow channel. When the molten TPU material is injected into the peripheral edge cavity of the cavity b2 of the lower mold of the mold B, the molten TPU material penetrates through the circular holes 30 in the waterproof and breathable fabric 3 and continues upward into the annular groove b3, fills the annular groove b3, and is cured in the annular groove b3, finally forming the gasket 111 located on the upper surface of the waterproof and breathable fabric 3.

In some embodiments of the present disclosure, the annular groove b3 aligned with the peripheral edge cavity is provided on the bottom surface of the upper mold B-1 of the mold B, so that the TPU material that is secondarily injected can penetrate through the circular holes 30 in the waterproof and breathable fabric 3 from bottom to top and flow into the annular groove b3. After curing, the gasket 111 is formed on the upper surface of the waterproof and breathable fabric 3. The gasket 111 and the pad 1 at a lower part together form an upper and lower clamping structure for the peripheral edge of the waterproof and breathable fabric 3, which significantly enhances fixing strength of the fabric edge and effectively prevents delamination. In addition, a cylinder penetrating through the circular holes 30 further provides an anchoring effect, thereby improving overall structural stability of the breathable device.

In some embodiments, as shown in FIG. 1B and FIG. 3, positioning posts 4 that are mutually corresponding are disposed within the cavity of the lower mold of the mold A and the cavity b2 of the lower mold of the mold B, and the inner ring component 11 is provided with positioning holes 100 matched with the positioning posts 4.

In some embodiments, the cavity of the lower mold of the mold A and the cavity of the lower mold of the mold B are respectively provided with at least two positioning posts 4 for foolproof positioning. Accordingly, the number of positioning holes 100 is at least two.

In some embodiments, dimensions of the positioning posts 4 and the positioning holes 100 may be set by a skilled person based on experience.

In some embodiments, the positioning posts 4 in the cavity of the lower mold of the mold A are configured to form the positioning holes 100 during injection molding of the inner ring component 11. Subsequently, when the inner ring component 11 is placed in the cavity b2 of the lower mold of the mold B, the positioning posts 4 at corresponding positions in the cavity b2 of the lower mold of the mold B are inserted into the positioning holes 100 on the inner ring component 11, thereby precisely fixing the inner ring component 11 to a predetermined position for secondary injection molding, and ensuring accuracy of relative positions of each component during subsequent injection molding of the TPU material.

In some embodiments of the present disclosure, the corresponding positioning posts 4 are disposed in the mold A and the mold B, and the positioning holes 100 are reserved on the inner ring component 11, so that the inner ring component 11 can be precisely fixed to a predetermined position in the mold B before the secondary injection molding. This ensures accuracy of a relative position among the pad 1, the waterproof and breathable fabric 3, and the gasket 111, avoiding problems such as misalignment between the breathable holes and the through holes of the shoe sole or uneven bonding at the peripheral edge caused by displacement of the inner ring component 11, and significantly improving the product yield and consistency of the breathable device.

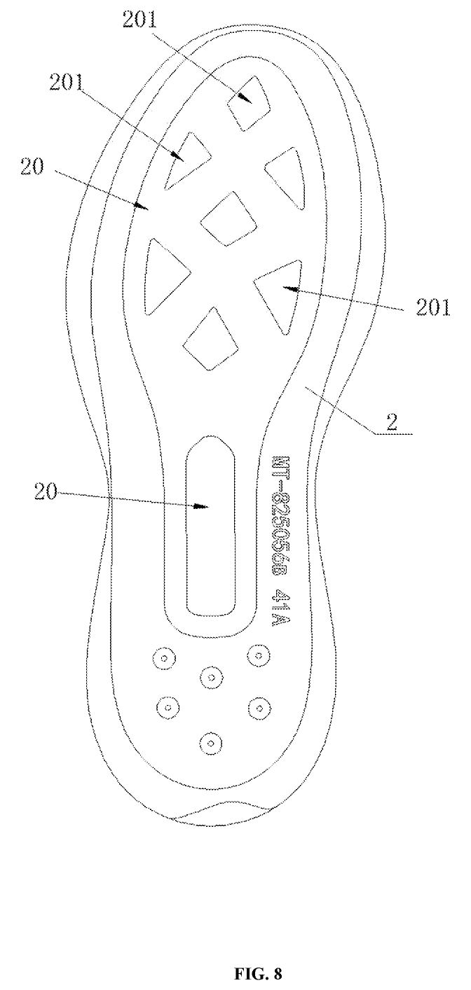

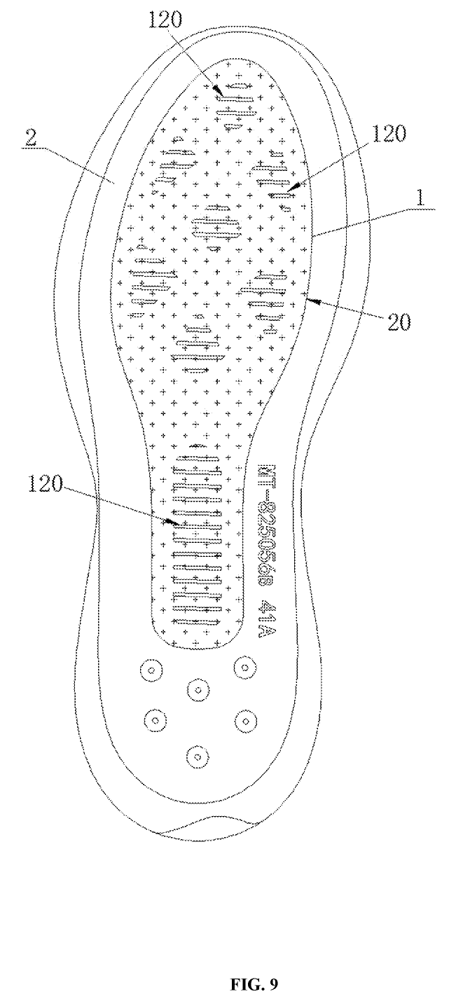

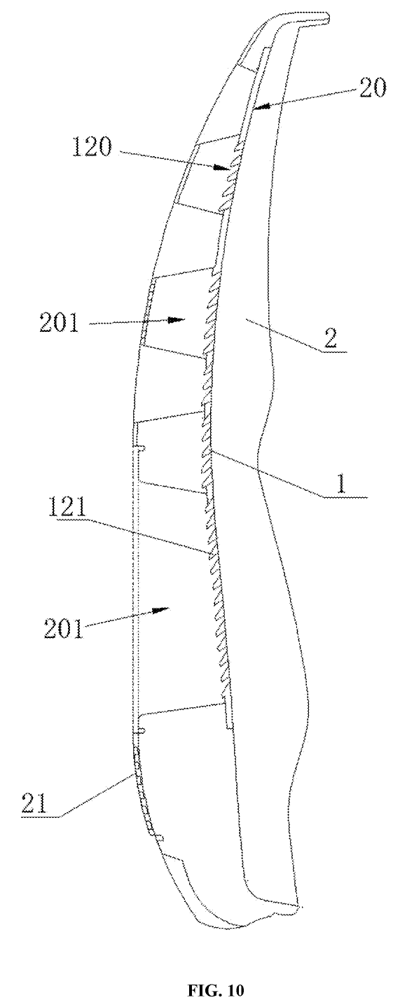

FIG. 8 is a schematic structural diagram of a midsole without a breathable device according to the present disclosure. FIG. 9 is a schematic structural diagram of a midsole with a breathable device according to the present disclosure. FIG. 10 is a schematic sectional structural diagram of a midsole with a breathable device according to the present disclosure.

In some embodiments, as shown in FIG. 8 to FIG. 10, some embodiments of the present disclosure further provide a shoe sole, and the shoe sole include a midsole 2, where an upper surface of the midsole is provided with the groove 20, the breathable device applied to the shoe sole is disposed within the groove 20, and a bottom of the groove 20 is penetrated by through holes 201 that are in one-to-one correspondence to the plurality of protrusions 12.

The midsole 2 is an intermediate layer component located between an outsole and an insole in a shoe sole structure, serving as a functional carrier for cushioning, support, and installation of the breathable device.

The groove 20 is configured to accommodate the breathable device. In some embodiments, a contour shape of the groove 20 matches with an outer edge of the breathable device. In some embodiments, a detachable fit (such as clearance fit, a magnetic structure, or a removable adhesive layer) is adopted between the groove 20 and the breathable device, so that the breathable device can be easily placed into the groove 20 and remain stable, and can also be removed from the groove 20 with a tool or manually when needed (such as for cleaning or maintenance), without damaging an overall structure of the midsole 2.

In some embodiments, a depth of the groove 20 may be set to be slightly less than an overall thickness of the breathable device, for example, the depth of the groove 20 may be set to 80%-100% of the overall thickness of the breathable device, so that a top surface of the installed breathable device is slightly lower than or flush with the upper surface of the midsole, avoiding an uncomfortable foreign body sensation on the sole of the foot.

The through hole 201 refers to a through hole that is provided on the midsole 2 and configured to communicate with the outside. The outside refers to an atmospheric environment outside the shoe sole, that is, an open space in communication with outside air when a footwear is worn.

In some embodiments, the through holes 201 are provided at the bottom of the groove 20 and penetrate through the midsole 2 in a thickness direction (that is, vertically downward from the upper surface of the midsole to the lower surface of the midsole), and can guide the outside air to the lower surface of the breathable device, so that air inside and outside the shoe can circulate via the breathable holes 120 and the waterproof and breathable fabric 3.

In some embodiments of the present disclosure, the groove 20 is provided on the upper surface of the midsole 2 that matches with the breathable device, and through holes corresponding to the protrusions 12 are provided at the bottom of the groove 20, and the breathable device can be stably embedded and precisely aligned in the shoe sole, ensuring that the outside air can smoothly enter the shoe through the through holes, the breathable holes, and the waterproof and breathable fabric. In addition, detachable fit between the groove 20 and the breathable device allows the breathable device to be removed, cleaned, or replaced as needed after long-term use, without damaging the overall structure of the shoe sole, thereby balancing breathability, structural stability, assembly reliability, and replaceability of the breathable device in the shoe sole.

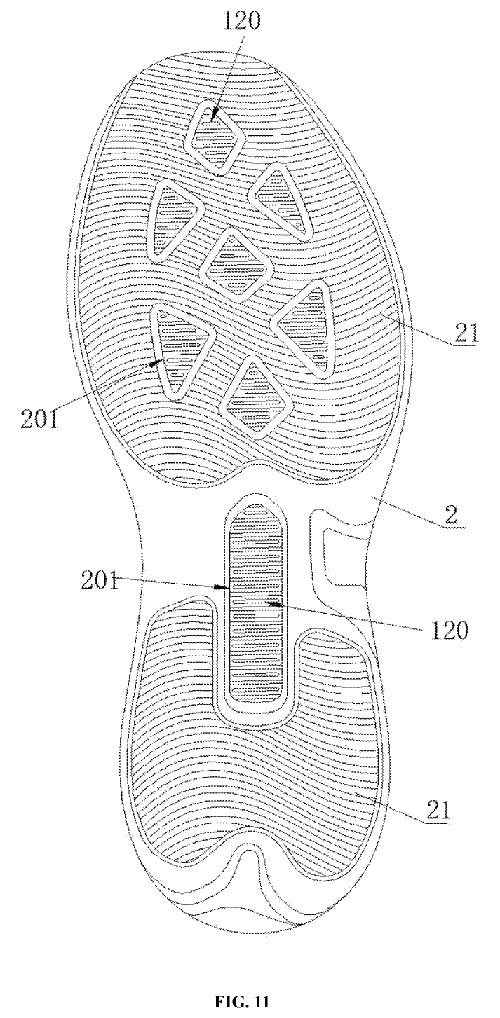

FIG. 11 is an upward schematic structural diagram of a shoe sole according to the present disclosure.

In some embodiments, as shown in FIG. 11, an outsole 21 is bonded to the bottom of the midsole 2, and anti-slip patterns are provided on a bottom surface of the outsole 21.

The outsole refers to an outer sole component bonded to a bottom of the midsole 2 and directly contacting the ground. In some embodiments, the bottom surface of the outsole 21 is provided with anti-slip patterns, mainly serving functions of wear resistance and slip resistance.

In some embodiments, the outsole 21 is provided with hollow portions that are in one-to-one correspondence to the protrusions 12 to ensure air circulation between the breathable device and the outside air.

In some embodiments of the present disclosure, the outsole 21 is bonded to the bottom of the midsole 2 of the shoe sole and the bottom surface of the outsole is provided with the anti-slip pattern. This significantly improves wear resistance and slip resistance of the shoe sole, effectively protects the midsole 2 and the internal breathable device from direct ground wear, and enhances walking stability and safety of a wearer on dry, wet, or uneven surfaces. In addition, the outsole 21 is provided with hollowed-out portions that are in one-to-one correspondence to the protrusions 12, ensuring that outside air can smoothly pass through the outsole and enter the breathable device, thereby preventing the outsole from covering and affecting breathability of the shoe sole. As a result, when durability and safety are improved, a normal air exchange function of the breathable device is also maintained.

Some embodiments of the present disclosure further provide a waterproof breathable shoe, and the waterproof breathable shoe includes a shoe upper and the shoe sole provided with a breathable device, where the shoe upper is connected to an upper end of the shoe sole.

The shoe sole provided with the breathable device is combined with the shoe upper, so that the shoe can achieve air exchange between the interior and exterior of the shoe during walking through compression and release of the sole of the foot, timely expelling hot and humid air. Meanwhile, the waterproof and breathable fabric 3 effectively blocks ingress of external liquid water, and keeps the interior of the shoe dry and comfortable. In addition, the breathable device has excellent puncture resistance, anti-clogging performance, and replaceability, which significantly enhances wearing safety, durability, and long-term breathable and waterproof performance of the shoe, and comprehensively improves foot health and wearing comfort.

The above are merely specific embodiments of the present disclosure, but the design concept of the present disclosure is not limited thereto. Any non-substantial modification made to the present disclosure by utilizing this concept shall be regarded as an act infringing the protection scope of the present disclosure.

What is claimed is:

1. A breathable device applied to a shoe sole, comprising: a pad and a waterproof and breathable fabric covering a surface of the pad, wherein a plurality of protrusions are disposed on the surface of the pad, a plurality of breathable holes are provided within the plurality of protrusions, a peripheral edge of the waterproof and breathable fabric is provided with a plurality of circular holes penetrating a thickness of the peripheral edge, and a gasket is laminated on the peripheral edge of the waterproof and breathable fabric and is integrally formed with the pad by penetrating through the circular holes.

2. The breathable device applied to the shoe sole according to claim 1, wherein trenches communicating with each other are formed between the plurality of protrusions, and the trenches are configured to fill an injection molding material during a secondary injection molding process to bond the waterproof and breathable fabric.

3. The breathable device applied to the shoe sole according to claim 2, wherein a plurality of bumps are disposed at bottoms of the trenches, and the plurality of bumps are configured to abut against the waterproof and breathable fabric.

4. The breathable device applied to the shoe sole according to claim 1, wherein the pad and the gasket are integrally injection-molded from a TPU (thermoplastic polyurethane) material.

5. The breathable device applied to the shoe sole according to claim 1, wherein each of the plurality of protrusions is provided with a plurality of inclined plates, and the plurality of breathable holes are formed between the plurality of inclined plates.

6. The breathable device applied to the shoe sole according to claim 1, wherein a thickness of the pad is 1-3 mm.

7. A preparation method for a breathable device applied to a shoe sole, the preparation method being applied to preparing the breathable device according to claim 1, wherein the preparation method comprises the following steps:
placing a TPU material into a cavity of a lower mold of a mold A; closing an upper mold of the mold A; heating for molding; and then cooling and opening the mold A to obtain an inner ring component, wherein the inner ring component is a semi-finished product of the breathable device, a surface of the inner ring component comprises the plurality of protrusions, a trench structure is formed between the plurality of protrusions, and all trenches are interconnected to form a grid shape;
taking a piece of the waterproof and breathable fabric; and punching holes in the piece of the waterproof and breathable fabric to form the plurality of circular holes, wherein the plurality of circular holes are adapted to the peripheral edge of the waterproof and breathable fabric and arranged in a circular shape;
placing the inner ring component obtained in a previous step into a cavity of a lower mold of a mold B; leaving a gap between the inner ring component and a peripheral side wall of the cavity of the lower mold of the mold B to form a peripheral edge cavity; hanging the waterproof and breathable fabric on an upper mold of the mold B; closing the upper mold of the mold B; injecting the TPU material into the cavity of the lower mold of the mold B; and bonding the inner ring component and the waterproof and breathable fabric through the TPU material to form an integrated structure; and
opening the mold B after cooling to obtain a primary breathable device; and trimming the waterproof and breathable fabric that is excessive along an edge of the primary breathable device to obtain the breathable device.

8. The preparation method for the breathable device applied to the shoe sole according to claim 7, wherein a bottom surface of the upper mold of the mold B is provided with an annular groove, the annular groove is aligned with the peripheral edge cavity, and the TPU material is capable of penetrating through the plurality of circular holes in the waterproof and breathable fabric and flows into the annular groove.

9. The preparation method for the breathable device applied to the shoe sole according to claim 7, wherein positioning posts that are mutually corresponding are disposed within the cavity of the lower mold of the mold A and the cavity of the lower mold of the mold B, and the inner ring component is provided with positioning holes matched with the positioning posts.

10. A shoe sole, comprising a midsole, wherein an upper surface of the midsole is provided with a groove, the breathable device applied to the shoe sole according to claim 1 is disposed within the groove, and a bottom of the groove is penetrated by through holes that are in one-to-one correspondence to the plurality of protrusions.

11. The shoe sole according to claim 10, wherein an outsole is bonded to a bottom of the midsole.
